(19) United States
(12) Patent Application Publication
(10) Pub. No.: US 2021/0238799 A1
(43) Pub. Date: Aug. 5, 2021

(54) INTERNAL RECIRCULATION PRINTING

(71) Applicant: Hewlett-Packard Development Company, L.P., Spring, TX (US)

(72) Inventors: John L. Stoffel, San Diego, CA (US); Dennis Z. GUO, San Diego, CA (US); Blair A. BUTLER, San Diego, CA (US)

(73) Assignee: Hewlett-Packard Development Company, L.P., Spring, TX (US)

(21) Appl. No.: 17/050,194

(22) PCT Filed: Aug. 30, 2018
(86) PCT No.: PCT/US2018/048720

§ 371 Date: Oct. 23, 2020

(51) Int. Cl. D06P 5/30; C09D 11/322; C09D 11/102; C09D 11/107; C09D 11/037; D06P 1/52; B41J 2/18; B41M 5/00

(52) U.S. Cl. CPC D06P 5/30; C09D 11/322; C09D 11/102; C09D 11/107; D06P 3/60; D06P 1/5285; D06P 1/525; B41J 2/18; B41M 5/0023; C09D 11/037

(57) ABSTRACT

A method of internal recirculation printing can include introducing an ink composition into a firing chamber, the ink composition comprising water, organic co-solvent, pigment, and from 2 wt % to 20 wt % of a dispersed polymer binder with an acid number from 0 mg KOH/g to 45 mg KOH/g, a weight average molecular weight of 40,000 Mw to 2,000,000 Mw, and a particle size from 40 nm to 2 μm. The method can further include internally recirculating ink composition from the firing chamber, through micro-recirculation fluidics, and back into the firing chamber to be again recirculated or ejected from the firing chamber, as well as ejecting ink composition from the firing chamber through a jetting nozzle onto a substrate.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF DRAWINGS

FIG. 1 provides a flow diagram for an example method of internal recirculation printing in accordance with the present disclosure;

FIG. 2 schematically depicts an example internal recirculation printhead assembly including an example ink composition and an example inkjet printhead assembly in accordance with the present disclosure;

FIG. 3 schematically depicts an example internal recirculation printing system, including a printhead assembly such as that shown in FIG. 2, with the ink composition being ejected onto a fabric substrate and exposed to thermal energy from a heat curing device in accordance with the present disclosure; and

FIG. 4 is a graph that plots washfastness (durability) against decap performance (printability) with multiple inks on a cotton fabric substrate in accordance with the present disclosure.

### DETAILED DESCRIPTION

The present technology relates to printing using pigmented ink compositions and internal recirculation, or internal micro-recirculation, which can be useful for printing durable ink compositions on a variety of substrates, including fabrics which may be subjected to harsh conditions, such as exposure to harsh environments during use, washing, ironing, etc.

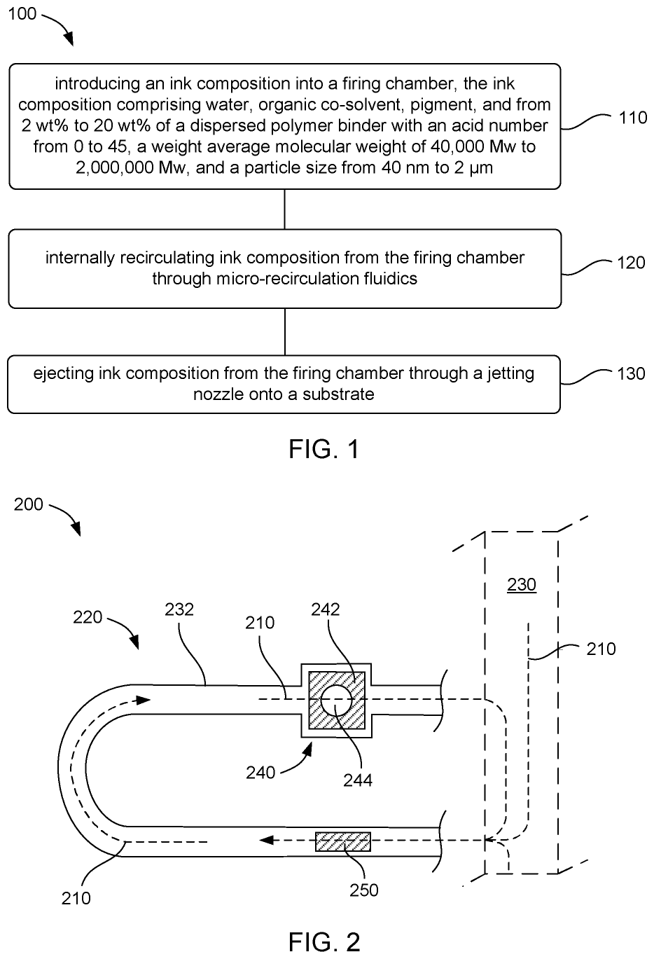

In accordance with this, the present disclosure includes an internal recirculation method 100 of printing, shown in FIG. 1 by way of example. The method includes introducing 110 an ink composition into a firing chamber, internally recirculating 120 ink composition from the firing chamber through micro-recirculation fluidics, and ejecting 130 ink composition from the firing chamber through a jetting nozzle onto a substrate. The ink composition includes water, organic co-solvent, pigment, and from 2 wt % to 20 wt % of a dispersed polymer binder with an acid number from 0 mg KOH/g to 45 mg KOH/g, a weight average molecular weight of 40,000 Mw to 2,000,000 Mw, and a particle size from 40 nm to 2 μm. In one example, the method can further include heating the substrate having the ink composition printed thereon to a temperature from 100° C. to 200° C. for a period of 30 seconds to 10 minutes. In another example, the polymer binder can include a polyurethane such as a polyester-type polyurethane binder; or a polyurethane such as a polyether-type polyurethane, a polycarbonate ester polyether-type polyurethane, or a polycarbonate-type polyurethane. The polymer binder can alternatively or additionally include acrylic latex particles. The substrate can be a fabric substrate including cotton, polyester, nylon, silk, or a blend thereof. In another example, recirculating the ink composition can occur via a fluid actuator within the micro-recirculation fluidics, where the fluid actuator causes pumping of the ink composition from a location outside of the firing chamber. In another example, the fluid actuator can include a thermal resistor, and cycling can include thermally pumping the ink composition at from 1 cycle to 5,000 cycles prior to or coincident with ejecting.

In another example, as illustrated by example in FIG. 2, an internal recirculation printhead assembly 200 includes an ink composition 210 and an inkjet printhead assembly 220 fluidically couplable to a supply 230 carrying the ink composition. The ink composition in this example includes organic co-solvent, pigment, and from 2 wt % to 20 wt % of a dispersed polymer binder having an acid number from 0 mg KOH/g to 45 mg KOH/g, a weight average molecular weight of 40,000 Mw to 2,000,000 Mw, and a particle size from 40 nm to 2 μm. The inkjet printhead assembly in this example includes a firing chamber 240 thermally coupled to a firing resistor 242 to eject the ink composition from the firing chamber through a jetting nozzle 244, and a pump 250 including a fluid actuator positioned outside of the firing chamber to recirculate the ink composition into and out of the firing chamber through micro-recirculation fluidics 232 in preparation for or during ejection of the ink composition through the jetting nozzle. The fluid actuator can include, for example, a thermal resistor. In one example, the ink composition is loaded in the inkjet printhead assembly, the supply carrying the ink composition is fluidly coupled to the inkjet printhead assembly, or both. Thus, the term “couplable” describes the relationship between multiple structures that are joinable, but can also be joined together either temporarily or permanently. The supply can be an ink cartridge supply, or in this instance as shown, is a larger fluidic channel that feeds the micro-recirculation fluidics (and may feed other micro-recirculation fluidics that may also be associated with its own firing chamber, firing resistor, nozzle and/or pump). Thus, the supply can be an ink cartridge, other supply fluidics, a fluid directing die, or other similar structure that may feed one or more micro-recirculation fluidic(s).

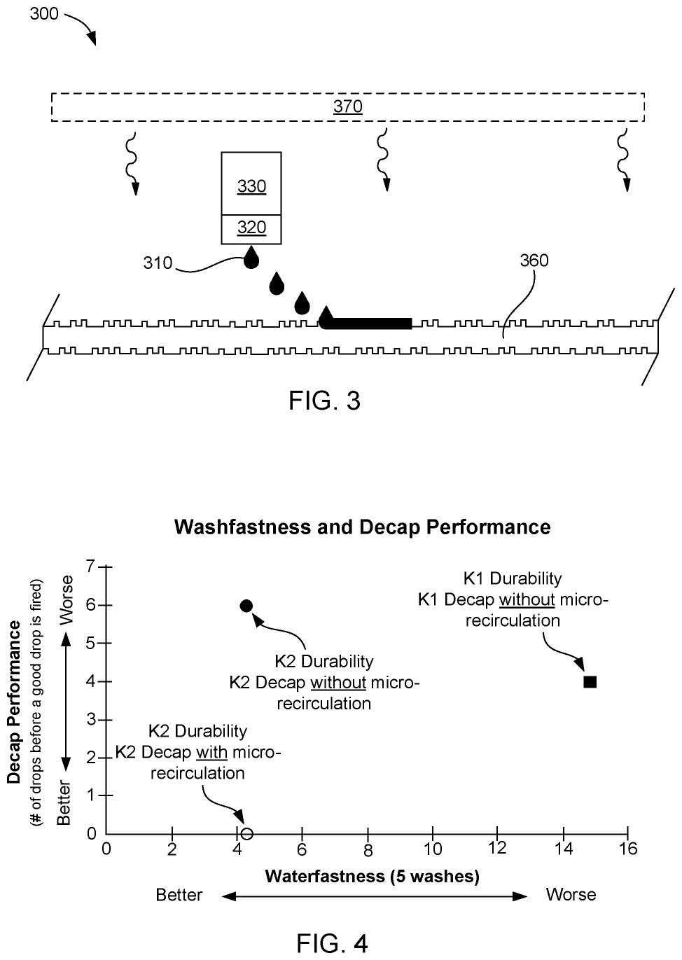

In another example, an internal recirculation printing system 300, as shown by way of example in FIG. 3, includes an ink composition 310, an inkjet printhead assembly 320, and a fabric substrate 360. The ink composition includes water, organic co-solvent, pigment, and from 2 wt % to 20 wt % of a dispersed polymer binder having an acid number from 0 mg KOH/g to 45 mg KOH/g, a weight average molecular weight of 40,000 Mw to 2,000,000 Mw, and a particle size from 40 nm to 2 μm. The inkjet printhead assembly includes a firing chamber thermally coupled to a firing resistor to eject the ink composition from the firing chamber through a jetting nozzle, and a pump including a fluid actuator outside of the firing chamber to recirculate the ink composition into and out of the firing chamber through micro-recirculation fluidics in preparation for or during ejection of the ink composition through the jetting nozzle, similar to that shown and described in FIG. 2. The fabric substrate in this example is to receive the ink composition ejected through the jetting nozzle. In one example, the internal recirculation printing system can include a heat curing device 370 to heat the fabric substrate having the ink composition printed thereon to a temperature from 100° C. to 200° C. for a period of 1 second to 5 minutes. The fabric substrate can include cotton, polyester, nylon, silk, or a blend thereof. The polymer binder can include dispersed polyurethane particles or acrylic latex particles. The pump, for example, can include a fluid actuator such as a thermal resistor or a piezoelectric element. The inkjet printhead assembly can be loaded with the ink composition and/or fluidically couplable or coupled to a supply 330 carrying the ink composition. In this instance, the supply is an ink supply cartridge, and the ink composition can be delivered through other supply fluidics to the inkjet printhead assembly.

As a note, with respect to the internal recirculation printing methods, printhead assemblies, and printing systems described herein, various specific descriptions can be considered applicable to other examples whether or not they are explicitly discussed in the context of that example. Thus, for example, in discussing a pigment related to the internal recirculation methods, such disclosure is also relevant to and directly supported in context of the internal recirculation printhead assemblies, the internal recirculation printing systems, etc., and vice versa.

Referring now to the internal recirculation that can occur with the methods, systems, and printhead assemblies described herein, it is noted that the term “internal recirculation” indicates that ink composition recirculation occurs behind the jetting orifice of the nozzle plate, e.g., prior to and in some instances during ink composition ejection out of the inkjet pen and into the environment outside of the inkjet pen, such as onto a substrate. Often, ink compositions which can provide good durability on certain challenging print substrates, such as fabric substrates, may be difficult to eject from inkjet printheads, such as thermal inkjet printheads. By cycling the ink composition through the firing chamber (without ejecting), the jetting nozzle, firing chamber, or other fluidic structures can be refreshed for printing with acceptable print quality, even if the ink would otherwise exhibit poor decap performance in an inkjet pen that does not use internal recirculation. In further detail, the term “recirculation” is in some ways synonymous with circulation of the ink composition through the microfluidics of the inkjet pen or printhead assembly, but is referred to as recirculation because the ink composition, or a portion thereof during recirculation, can enter a firing chamber (where it could be ejected from the ejection nozzle), but in many instances, instead of being ejected from the firing chamber, can be circulated through microfluidics out of the firing chamber to later return to the firing chamber or introduced into a second firing chamber that may be fluidically coupled to the (initial) firing chamber. In other words, recirculation refers to the movement of ink composition into and then out of a firing chamber (and then back into the firing chamber or another firing chamber), as well as into the firing chamber for ejection, regardless of whether a specific portion of the ink composition itself has been recirculated or not, e.g., if some of the ink composition is recirculated then the ink composition is collectively considered to have been recirculated.

In more specific detail regarding the pumps that can be used for internal recircualation in accordance with the present disclosure, in one example, the pump can include a thermal resistor or a piezoelectric pumping element within a microfluidic channel of the printhead. The term “microfluidic” refers to fluid channels that are from about 5 μm to about 100 μm in diameter or average cross-sectional size (for non-circular cross-sectional channels or lumens). A thermal resistor, for example, can form bubbles to displace fluid, such as ink compositions, in the microfluidic channels. A piezoelectric element can repeatedly actuate a fluid to cause fluid flow. In one example, the pump can be located asymmetrically with respect to the length of the microfluidic channels (closer to one end or another) relative to a fluid source, e.g., supply, fluid directing die, etc., which can create a net fluid flow in one direction. Thus, the fluid flow can be similar to that of an inertial pump, where the thermal resistor or piezoelectric element can be cycled to circulate fluid through a loop (or loops) of the microfluidic channels. The various channels can individually include both the pump (with a fluid actuator, which can include a thermal resistor or a piezoelectric element, for example) as well as a firing chamber with a thermal (ink firing) resistor (at a separate location) along a microfluidic channel. Thus, the pump (which can be a thermal resistor, a piezoelectric element, or the like) can be used for recirculating the ink composition and the firing chamber can include a thermal resistor or other element for ejecting ink composition from a firing chamber. When recirculating the ink composition through the microfluidics, in some examples, the pumps can be cycled from 1 cycle to 5,000 cycles (for internal cycling of the ink composition), for example, before or coincident with fluid ejection from the firing chamber out through the printing nozzle. In other examples, from 50 cycles to 4,000 cycles, or from 100 cycles to 3,500 cycles, or from 1,000 cycles to 3,000 cycles can be carried out prior to or coincident with ink composition ejection. This wide range in the number of cycles can be due to the wide variety of ink formulations, fluidic designs, how long the ink remains been static within the recirculation circuit, etc. As a note, the term “pump cycle” or “cycle” refers to the cycling of the pump, not the movement of a portion of ink fully around a microfluidic recirculation circuit. Multiple pump cycles may move the ink fully around a fluidic circuit, and due to design possibilities, some ink portions may never fully circulate as they may get diverted to other channels, etc.

In further detail, the microfluidic printheads described herein can include multiple pumps fluidly which feed (and circulate fluid) to a common firing chamber. In other examples, a single pump can feed multiple firing chambers. In still other examples, multiple pumps can feed multiple firing chambers. These arrangements are appropriate to the extent that they can be used to create ink composition circulation suitable for freshening ink compositions and firing chamber architecture for reliable ink composition ejection.

In further detail regarding the pumps, as mentioned, the pump can include a fluid actuator. In one example, the fluid actuator can be a thermal resistor to generate vapor bubbles to displace fluid in the microfluidic channel. Specifically, the thermal resistor can be powered to quickly heat the fluid over the resistor past the boiling point of the fluid. This can produce a bubble that expands to force surrounding fluid in the microchannel away from the resistor and then collapses. Piezoelectric elements can likewise be used, which operate similarly to thermal resistors, except that instead of a resistor forming a bubble to displace fluid, a current can be applied to the piezoelectric element to cause the piezoelectric element to change shape and displace fluid in the microfluidic channel. When the current to the piezoelectric element is turned off, the piezoelectric element can return to its original shape.

In some examples, the internal recirculation printhead assembly can further include various types of valving or other structural discontinuities along the microfluidic flow path to prevent backflow and provide forward movement even against head pressure that may be present that may otherwise reduce fluid flow. However, inertial pumping can be carried out without a valve or other structure to resist backflow. Whether backflow valving is present or not, the volume around the collapsed bubble (generated by the thermal resistor actuator) or rapidly reshaping element (generated by electrical interaction with the piezoelectric actuator) can be filled by drawing more fluid from upstream of the actuator, thus creating a net flow rate downstream (in the direction of the dashed arrow in FIG. 2). It is noted that though the net flow rate is downstream, the firing chamber could be positioned either downstream (pushing the ink composition into and through the firing chamber) or upstream (drawing the ink composition into and through the firing chamber). Either way, the direction of flow can be induced by the location of the pump asymmetrically positioned within the channel (e.g., closer to the ink composition fluid supply), by the presence of backflow-prevention valving, by the use of vertical recirculation, or by other similar structural arrangements that can provide a net flow of micro-recirculation through the firing chamber (to be ultimately ejected from the firing chamber after micro-recirculation using the pump(s)).

As used herein, “downstream” normally refers to the direction of fluid flow that a pump generates when active. “Upstream” refers to the fluid flow that feeds the pump when active. In some examples, a one-way valve can be located downstream of the fluid actuator of the pump, upstream from the fluid actuator, or both. In other examples, there may be no one-way valve used. When the pump is active, the fluid actuator can repeatedly fire, moving fluid downstream, which either pushes the ink composition toward the firing chamber for ink composition micro-recirculation, or draws the ink through the firing chamber for ink composition micro-recirculation.

Turning to more specific detail regarding the components of the ink compositions that can be used for the internal recirculation methods, assemblies, and systems described herein, the pigment can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155.

The pigment can be dispersed by a dispersant, such as a styrene (meth)acrylate dispersant, or another dispersant suitable for keeping the pigment suspended in the liquid vehicle. For example, the dispersant can be any dispersing (meth)acrylate polymer, or other type of polymer, such as maleic polymer or a dispersant with aromatic groups and a poly(ethylene oxide) chain. In one example, however, the (meth)acrylate polymer can be a styrene-acrylic type dispersant polymer, as it can promote π-stacking between the aromatic ring of the dispersant and various types of pigments, such as copper phthalocyanine pigments, for example. In one example, the styrene-acrylic dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, or from 15,000 Mw to 20,000 Mw. Molecular weight can be measured by gel permeation chromatography. Regarding the acid number, the styrene-acrylic dispersant can have an acid number from 100 mg KOH/g to 350 mg KOH/g, from 120 mg KOH/g to 350 mg KOH/g, from 150 mg KOH/g to 300 mg KOH/g, from 180 mg KOH/g to 250 mg KOH/g, or about 214 mg KOH/g, for example. Example commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). This can be the case for either dispersant polymer for pigment dispersion or for dispersed polymer binder that may include co-polymerized acrylate and/or methacrylate monomers. Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

Pigments and dispersants have been described separately above, but there are several more specific example combinations that can be used. For example, the pigment can be carbon black pigment with a styrene acrylic dispersant; PB 15:3 (cyan pigment) with styrene acrylic dispersant or with a self-dispersed moiety attached to a surface thereof; PR122 (magenta) or a combination PR122/PV19 (magenta) with styrene acrylic dispersant or with a self-dispersed moiety attached to a surface thereof; PY74 (yellow) or PY155 (yellow) with styrene acrylic dispersant. When the styrene acrylic dispersant is used, molecular weights of the polymer dispersant can be from 7,000 Mw to 12,000 Mw, or from 8,000 Mw to 11,000 Mw, for example. The acid number of the styrene acrylic dispersant can be from 150 mg KOH/g to 200 mg KOH/g, or from 155 mg KOH/g to 185 mg KOH/g, for example. Two of the pigments colorants mentioned herein are described as including a self-dispersed moiety. Those and other self-dispersed pigments can be obtained from Cabot Corporation (USA), e.g., Cabojet® 250C (cyan) and Cabojet® 265M (magenta).

Regarding the polymer binder, this component can provide improved durability when the ink compositions described herein are printed on a substrate, such as a fabric substrate, even when the fabric substrate is expected to undergo multiple washing cycles, such as in a clothes washing machine. However, polymer binders that are added to provide good durability often tend to be difficult to eject from inkjet printheads over a sustained period of time, e.g., such as thermal inkjet printheads where even short duration decap can cause the jetting nozzles to become clogged, etc. For example, durable ink compositions prepared to include a dispersed polymer (40 nm to 2 μm) with a relatively high molecular weight (40,000 Mw to 2,000,000 Mw) and a relatively low acid number or acid value (0 mg KOG/g to 45 mg KOH/g) may exhibit poor thermal inkjet decap performance. Thus, some of these more durable ink compositions with robust polymer binder particles can be printed on various substrates, such as fabric substrates, using micro-recirculation to refresh the ink composition and the ejection architecture prior to ink composition ejection onto the substrate with good success, e.g., providing both durability and reliable jettability. To illustrate, by cycling the ink composition through the firing chamber (without ejecting), e.g., using about 500 to about 5,000 pumping resistor cycles, the jetting nozzle can be refreshed for printing with acceptable print quality, even if the ink otherwise exhibits poor decap performance without micro-recirculation.

Polymer binders with these properties include various polyurethane particles, as well as various acrylic latex particles. Regarding the polyurethane type polymer binder particles, IMPRANIL® DLN-SD polymer (CAS #375390-41-3; Mw 133,000 Mw; Acid Number 5.2 mg KOH/g; Tg—47° C.; Melting Point 175-200° C. from Covestro, Germany) can provide acceptable durability when printed on fabric, even after multiple wash cycles, though in many instances it can be difficult to retain acceptable decap performance when included at levels that may provide durability utility. This compound can be relatively water-insoluble, as it may also be aliphatic including saturated carbon chains therein as part of the polymer backbone or side-chain thereof, e.g., C2 to C10, C3 to C8, or C3 to C6 alkyl. These types of polymer binders can be likewise described as “aliphatic polyurethanes” because these carbon chains are saturated and because they are devoid of aromatic moieties. Example components used to prepare the IMPRANIL® DLN-SD or other similar anionic aliphatic polyester-polyurethane binders can include pentyl glycols, e.g., neopentyl glycol; C4-C8 alkyldiol, e.g., hexane-1,6-diol; C3 to C5 alkyl dicarboxylic acids, e.g., adipic acid; C4 to C8 alkyl diisocyanates, e.g., hexamethylene diisocyanate (HDI); diamine sulfonic acids, e.g., 2-[(2-aminoethyl)amino]-ethanesulfonic acid; etc. Other IMPRANIL® polyurethanes can also be used, including IMPRANIL® DL 1380 (polyester-type polyurethane), IMPRANIL® DLU (polycarbonate ester-polyether-type polyurethane), or IMPRANIL® LP DSB (polyether-type polyurethane). DISPERCOLL® U42 (CAS #157352-07-3 from Covestro, Germany). DISPERCOLL® U42 is an example of an aromatic polyester-polyurethane binder, which can be prepared with aromatic dicarboxylic acids, e.g., phthalic acid; C4 to C8 alkyl dialcohols, e.g., hexane-1,6-diol; C4 to C8 alkyl diisocyanates, e.g., hexamethylene diisocyanate (HDI); diamine sulfonic acids, e.g., 2-[(2-aminoethyl)amino]-ethanesulfonic acid; etc. Other polyurethanes that can be used include HYDRAN® WLS-201, HYDRAN® WLS-201K, TAKELAC® W-6061T, or TAKE LAC® WS-6021, which are polyether-type polyurethanes. HYDRAN® WLS 213 or TAKELAC® W-6110, both of which are polycarbonate-type polyurethanes, can also be used as the polymer binder. HYDRAN® polyurethanes are available from DIC (Japan), and TAKELAC® polyurethanes are available from Mitsui (Japan).

With regard to the acrylic latex polymer particles that can be used, any of a number of acrylic-based latexes can provide good durability to an image printed from the compositions of the present disclosure. For example, the acrylic latex polymer particles can include copolymerized acrylic and/or methacrylic monomers, or copolymerized styrene with acrylic and/or methacrylic monomers, e.g., to form styrene-acrylic copolymers. More generally, in various examples, the acrylic latex polymer (or particles) can be formed from a variety of monomers, including (meth)acrylic or (meth)acrylate monomer(s). Monomers copolymerized therewith can include various vinyl monomers, allylic monomers, olefin monomers, unsaturated hydrocarbon monomers, or combinations thereof. Classes of vinyl monomers can include vinyl aromatic monomers (e.g., styrene), vinyl aliphatic monomers (e.g., butadiene), vinyl alcohols, vinyl halides, vinyl esters of carboxylic acids (e.g., vinyl acetate), vinyl ethers, (meth)acrylamides, (meth)acrylonitriles, or mixtures of two or more of the above, for example. Examples of vinyl aromatic monomers that may be included can include styrene, 3-methylstyrene, 4-methylstyrene, styrene-butadiene, p-chloromethylstyrene, 2-chlorostyrene, 3-chlorostyrene, 4-chlorostyrene, divinyl benzene, vinyl naphthalene and divinyl naphthalene. Vinyl halides can include, for example, vinyl chloride and vinylidene fluoride. Vinyl esters of carboxylic acids can include, for example, vinyl acetate, vinyl butyrate, vinyl methacrylate, vinyl 3,4-dimethoxybenzoate, vinyl maleate and vinyl benzoate. Examples of vinyl ethers can include butyl vinyl ether and propyl vinyl ether.

In further detail, the polymer binder can have an average particle size from 40 nm to 2 μm, from 40 nm to 500 nm, from 50 nm to 350 nm, from 100 nm to 1 μm, or from 100 nm to 500 nm, for example. The particle size of any solids herein, including the average particle size of the dispersed polymer binder, can be determined using a Nanotrac® Wave device, from Microtrac, e.g., Nanotrac® Wave II or Nanotrac® 150, etc, which measures particles size using dynamic light scattering. Average particle size can be determined using particle size distribution data generated by the Nanotrac® Wave device. The weight average molecular weight of the polymer binder can be from 40,000 Mw to 2,000,000 Mw, from 50,000 Mw to 1,000,000 Mw, from 50,000 Mw to 500,000 Mw, from 100,000 Mw to 400,000 Mw, or from 150,000 Mw to 300,000 Mw. Molecular weight can be measured by gel permeation chromatography. The acid number of the polymer binder can be from 0 mg KOH/g to 45 mg KOH/g, from 1 mg KOH/g to 45 mg KOH/g, or from 1 mg KOH/g to 40 mg KOH/g, or from 5 mg KOH/g to 30 mg KOH/g, for example. The term “acid value” or “acid number” refers to the mass of potassium hydroxide (KOH) in milligrams that can be used to neutralize one gram of substance (mg KOH/g), such as the latex polymers disclosed herein. Acid number values or ranges can be shown either with or without notating the specific units, e.g., mg KOH/g. The test for determining the acid number of a particular substance may vary, depending on the substance. For example, to determine the acid number of the polyurethane-based or the acrylic latex-based binder, a known amount of a sample of the binder may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (also referred to as PolyDADMAC).

The ink compositions of the present disclosure can be formulated to include an aqueous liquid vehicle, which can include water, e.g., 50 wt % to 90 wt % or from 60 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, emulsifier, other colorant, etc. However, as part of the ink compositions used herein, in addition to the liquid components, the pigment (dispersed by a separate dispersing agent or with a surface-attached dispersing agent) and the polymer binder are included amongst the solids that are carried by the liquid vehicle. Example pH ranges for the ink composition can be from pH 6 to pH 11, from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8, though pH levels outside of these ranges can also be used.

In further detail regarding the aqueous liquid vehicle, the organic co-solvent(s) can be present and can include any co-solvent or combination of co-solvents that is compatible with the pigment (and dispersant) and polymer binder selected for use. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The aqueous liquid vehicle can also include surfactant and/or emulsifier. In general, the surfactant can be water-soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives known to those skilled in the art to modify properties of the ink as desired.

The internal recirculation methods, printhead assemblies, and printing systems of the present disclosure can be adapted to print on a variety of substrates. However, in one example, the substrate can be a fabric substrate. In accordance with this, there are many types of textiles that can be used for the fabric substrate, such as cotton fibers, including treated and untreated cotton substrates, polyester substrates, cotton/polyester blends, nylons, silks, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

As mentioned, in some examples, the fabric substrate can include natural fiber and synthetic fiber, e.g., cotton/polyester blend. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

It is notable that the term “fabric substrate” or “fabric” does not include materials commonly known as any paper (even though paper can include multiple types of natural and synthetic fibers or mixtures of both types of fibers). Fabric substrates can include textiles in filament form, textiles in the form of fabric material, or textiles in the form of fabric that has been crafted into a finished article, e.g., clothing, blankets, tablecloths, napkins, towels, bedding material, curtains, carpet, handbags, shoes, banners, signs, flags, etc. In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process, e.g., a solvent treatment, a mechanical treatment process, e.g., embossing, a thermal treatment process, or a combination of multiple processes.

The fabric substrate can have a basis weight ranging from about 10 gram per square meter (gsm) to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blend thereof, treated, untreated, etc., the fabric substrates printed with the ink composition of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). Essentially, by measuring OD and/or L*a*b* both before and after washing, ΔOD and ΔE values can be determined, which is essentially a quantitative way of expressing the difference between the OD and/or L*a*b* prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of about 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} (1976) is used.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Preparation of Ink Compositions

Four (4) ink compositions were prepared with two different pigment dispersions (black and cyan) and two (2) different polyurethane binders (IMPRANIL® DLN-SD and PUG 542) using the ink composition formulations shown in Table 1. The IMPRANIL® DLN-SD was prepared from polyester of hexandiol, neopentyl glycol and adipic acid, hexamethylene-1,6-diisocyanate and diaminosulphonate of the formula H₂N—CH₂—CH₂—NH—CH₂—CH₂—SO₃—Na (CAS #375390-41-3). PUG 542 is a polyurethane polymer binder and was prepared from isophorone diisocyanate, copolymer of methyl methacrylate-co-ethylhexylacrylate-co-ethoxyethoxyethylacrylate, polypropylene glycol (Mₙ 1000 g/mol), dimethylolpropionic acid and sodium 2-[(2-aminoethyl)amino]ethanesulphonate.

TABLE 1
Ink Composition Formulations

| Ingredient | Category | K1 (wt %) | K2 (wt %) | C1 (wt %) | C2 (wt %) |
|---|---|---|---|---|---|
| Glycerol | Organic Co-solvent | 8 | 8 | 8 | 8 |
| LEG-1 | Organic Co-solvent | 1 | 1 | 1 | 1 |
| Crodafos ® N3 Acid | Anti-kogation agent | 0.5 | 0.5 | 0.5 | 0.5 |
| Surfynol ® 440 | Surfactant | 0.3 | 0.3 | 0.3 | 0.3 |
| Acticide ® B20 (as is) | Biocide | 0.044 | 0.044 | 0.044 | 0.044 |
| IMPRANIL ® DLN-SD | Polyurethane | — | 6 | — | 6 |
| (133,000 Mw; 5.2 mg | Polymer Binder | | | | |
| KOH/g; 150 nm) | Solids | | | | |
| PUG 542 | Polyurethane | 6 | — | 6 | — |
| (30,000 Mw; 49 mg | Polymer Binder | | | | |
| KOH/g; 25 nm) | Solids | | | | |
| Carbon Black Pigment | Black Pigment | 2.5 | 2.5 | — | — |
| (K) dispersed by | Dispersion Solids | | | | |
| styrene acrylic | | | | | |
| Pigment Blue 15:3 (C) | Cyan Pigment | — | — | 2.5 | 2.5 |
| dispersed by styrene | Dispersion Solids | | | | |
| acrylic | | | | | |
| Deionized Water | Water (solvent) | Balance | Balance | Balance | Balance |

Crodafos ® is from Croda International Plc. (Great Britain).
Surfynol ® is from Evonik Industries AG (Germany).
Acticide ® B20 is from Thor Specialties (USA).
IMPRANIL ® is a polyester-type polyurethane from Covestro (Germany).

### Example 2—Decap Performance of Ink Compositions

The black and cyan inks prepared in accordance with Example 1 were tested for thermal jettability, and more specifically, for decap performance from a thermal inkjet pen. Decap time often refers to the amount of time that a printhead may be left uncapped before the printer nozzle no longer fires properly, potentially because of clogging or plugging. In this example, rather than reporting decap time, after experiencing “decapped” conditions for approximately 0.5 seconds, a test was conducted to determine how many drops would be fired before the first “good” drop was generated. A “good” drop can be characterized as a full droplet ejected without trajectory deviation. Missing column data was also collected. A missing column is defined as the number of printed columns missing after a 10 second wait time.

For comparison, the two ink compositions with IMPRANIL® DLN-SD, which performed the poorest with respect to decap performance (without micro-recirculation), were also loaded into an experimental printer with an inkjet printhead assembly having micro-recirculation architecture similar to that shown in FIG. 2. The decap data was also collected for this second type of printer. The data collected from the four inks with respect to decap performance is provided in Table 2, as follows:

TABLE 2
Decap Performance

| | | Decap | | Decap | |
|---|---|---|---|---|---|
| | | (without micro- | | (with micro- | |
| | | recirculation) | | recirculation) | |
| | | Missing | # of | Missing | # of |
| | | Columns | Poor Drops | Columns | Poor Drops |
| Ink | Polymer | (after 10 | (after 0.5 | (after 10 | (after 0.5 |
| ID | Binder ID | sec. wait) | sec. wait) | sec. wait) | sec. wait) |
| K1 | PUG 542 | 3 | 4 | — | — |
| K2 | IMPRANIL ® | 4 | 6 | 0 | 0 |
| | DLN-SD | | | | |
| C1 | PUG 542 | 2 | 3 | — | — |
| C2 | IMPRANIL ® | 4 | 5 | 0 | 0 |
| | DLN-SD | | | | |

As can be seen from Table 2, inks K2 and C2 performed poorly with respect to decap performance (without micro-recirculation) relative to K1 and C1 from a thermal inkjet pen that does not use micro-recirculation. For both the black comparison (K1 vs K2) and the cyan comparison (C1 vs C2), the ink compositions with IMPRANIL® DLN-SD used an additional two firing drops before a good drop could be generated compared to the ink compositions containing the PUG 542. Furthermore, with respect to the missing column testing where a lot more drops are fired, but the decapped time frame was increased to 10 seconds, the ink compositions with IMPRANIL® DLN-SD missed one (K2) or two (C2) additional columns compared to the same ink which included PUG 542 as the polymer binder. However, once these same inks (K2 and C2) were loaded into a printer with a thermal inkjet printhead assembly with micro-recirculation architecture in place, there was no longer a decap performance issue, e.g., no poor drops were ejected and no columns were missing upon printing. With micro-recirculation, the pump used for micro-recirculation of the ink composition within the microfluidic channels or tubes in this particular example was cycled a few thousand times prior to ejecting the ink composition, which prevented the inks and the printhead from experiencing decap performance issues under these timing and ejection conditions.

### Example 3—Washfastness of Ink Compositions

The black and cyan inks prepared in accordance with Example 1 were also tested for durability. More specifically, the various inks were screened for washfastness on two different types of fabrics, namely cotton (natural fibers) and nylon (synthetic fibers). Table 3 provides the data collected from the four inks (K1, K2, C1, and C2) from Example 1. In printing the various ink composition samples on both different types of fabric, a durability plot was printed with an ink density of 20 grams per square meter (gsm) using a thermal inkjet printhead. After printing, the samples were allowed to dry and the printed substrates were heat cured at 150° C. for 3 minutes. The printed fabric samples were then evaluated to obtain L*a*b* color space values, which represented the “pre-washing” values, or reference black or cyan values. Then, the printed fabric substrates were washed at 40° C. with laundry detergent (e.g., Tide® available from Proctor and Gamble, Cincinnati, Ohio, USA) for 5 cycles, air drying the printed fabric substrates between washing cycles. After the five cycles, L*a*b* values were measured for comparison. The delta E (ΔE) values were calculated using the 1976 standard denoted as ΔE_{CIE}. The data is provided in Table 3, as follows:

TABLE 3
Washfastness of Black and Cyan Ink Compositions
on Natural Fabric and Synthetic Fabric

| Ink ID | Polymer Binder ID | ΔE_{CIE} Cotton | ΔE_{CIE} Nylon |
|---|---|---|---|
| K1 | PUG 542 | 14.8 | 45.3 |
| K2 | IMPRANIL ® DLN-SD | 4.3 | 4.4 |
| C1 | PUG 542 | 23.4 | 47.9 |
| C2 | IMPRANIL ® DLN-SD | 5.2 | 3.2 |

In Table 3 above, a ΔE_{CIE} of less than about 5 may be considered good performance, and a ΔE_{CIE} of about 5 to about 10 may be considered marginal performance. A ΔE_{CIE} from above about 10 may be considered poor performance, and above about 20 may be considered very poor performance. As demonstrated, all other variables being equal, the durability of IMPRANIL® DLN-SD polyurethane exhibited much better washfastness than PUG 542, which is also a polyurethane, but does not fall within the parameters of having an acid number from 0 mg KOH/g to 45 mg KOH/g, a weight average molecular weight of 40,000 Mw to 2,000,000 Mw, and a particle size from 40 nm to 2 μm.

### Example 4—Washfastness Vs. Decap Performance

For comparison, ink compositions K1 and K2 were graphed for washfastness on a cotton substrate and decap performance from a thermal inkjet pen. K1 was the best performing ink composition with respect to durability (on cotton), so this ink was compared graphically to ink composition K2, which had good durability but did not perform well with respect to decap. K2 included IMPRANIL® DLN-SD, which is a polyester-type anionic aliphatic polyurethane polymer binder that can be used in accordance with examples of the present disclosure, e.g., 5.2 mg KOH/g; 133,000 Mw). PUG 542, on the other hand, does not fit the polymer profile of having an acid number from 0 mg KOH/g to 45 mg KOH/g and a weight average molecular weight of 20,000 Mw to 2,000,000 Mw. Rather, PUG 542 has an acid number of 49 mg KOH/g, a weight average molecular weight of 30,000 Mw and a particle size of 25 nm. The data for this comparison is shown in FIG. 4, with an additional data point showing no decap issues when micro-recirculation architecture is used.

As shown in FIG. 4, and as evident by the prior examples, the ink compositions (K2 and C2) with IMPRANIL® DLN-SD polymer binder exhibited better washfastness durability than the comparative ink compositions (K1 and C1). The decap performance was not as good with ink compositions K2 and C2, but this could be ameliorated by using an inkjet printer with micro-recirculation architecture, where decap after 0.5 seconds was non-existent.

While the present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A method of internal recirculation printing, comprising:
introducing an ink composition into a firing chamber, the ink composition comprising water, organic co-solvent, pigment, and from 2 wt % to 20 wt % of a dispersed polymer binder with an acid number from 0 mg KOH/g to 45 mg KOH/g, a weight average molecular weight of 40,000 Mw to 2,000,000 Mw, and a particle size from 40 nm to 2 μm;
internally recirculating ink composition from the firing chamber through micro-recirculation fluidics; and
ejecting ink composition from the firing chamber through a jetting nozzle onto a substrate.

2. The method of claim 1, further comprising heating the substrate having the ink composition printed thereon to a temperature from 100° C. to 200° C. for a period of 30 seconds to 10 minutes.

3. The method of claim 1, wherein the polymer binder comprises a polyester-type polyurethane binder.

4. The method of claim 1, wherein the polymer binder comprises a polyether-type polyurethane, a polycarbonate ester polyether-type polyurethane, or a polycarbonate-type polyurethane.

5. The method of claim 1, wherein the polymer binder comprises acrylic latex particles.

6. The method of claim 1, wherein the substrate is a fabric substrate including cotton, polyester, nylon, silk, or a blend thereof.

7. The method of claim 1, wherein internally recirculating the ink composition occurs via a fluid actuator within the micro-recirculation fluidics, wherein the fluid actuator causes pumping of the ink composition from location outside of the firing chamber.

8. The method of claim 7, wherein the fluid actuator includes a thermal resistor, and cycling includes thermally pumping the ink composition at from 1 cycle to 5,000 cycles prior to or coincident with ejecting.

9. An internal recirculation printing system, comprising:
an ink composition, comprising water, organic co-solvent, pigment, and from 2 wt % to 20 wt % of a dispersed polymer binder having an acid number from 0 mg KOH/g to 45 mg KOH/g, a weight average molecular weight of 40,000 Mw to 2,000,000 Mw, and a particle size from 40 nm to 2 μm;
an inkjet printhead assembly, including:
a firing chamber thermally coupled to a firing resistor to eject the ink composition from the firing chamber through a jetting nozzle, and
a pump including a fluid actuator positioned outside of the firing chamber to internally recirculate the ink composition into and out of the firing chamber through micro-recirculation fluidics; and
a fabric substrate to receive the ink composition ejected through the jetting nozzle.

10. The internal recirculation printing system of claim 9, further comprising a heat curing device to heat the fabric substrate having the ink composition printed thereon to a temperature from 100° C. to 200° C. for a period of 30 seconds to 5 minutes.

11. The internal recirculation printing system of claim 9, wherein the fabric substrate includes cotton, polyester, nylon, silk, or a blend thereof.

12. The internal recirculation printing system of claim 9, wherein the polymer binder includes dispersed polyurethane particles or acrylic latex particles.

13. The internal recirculation printing system of claim 9, wherein the fluid actuator includes thermal resistor.

14. An internal recirculation printhead assembly, comprising:
an ink composition, comprising water, organic co-solvent, pigment, and from 2 wt % to 20 wt % of a dispersed polymer binder having an acid number from 0 mg KOH/g to 45 mg KOH/g, a weight average molecular weight of 40,000 Mw to 2,000,000 Mw, and a particle size from 40 nm to 2 μm; and
an inkjet printhead assembly fluidically coupable to a supply carrying the ink composition, the inkjet printhead assembly, including:
a firing chamber thermally coupled to a firing resistor to eject the ink composition from the firing chamber through a jetting nozzle, and
a pump including a fluid actuator outside of the firing chamber to internally recirculate the ink composition into and out of the firing chamber through micro-recirculation fluidics.

15. The internal recirculation printhead assembly of claim 14, wherein the ink composition is loaded in the inkjet printhead assembly, the supply carrying the ink composition is fluidly coupled to the inkjet printhead assembly, or both.
